(19) United States
(12) Patent Application Publication
(10) Pub. No.: US 2016/0172136 A1
(43) Pub. Date: Jun. 16, 2016

(54) HALL EFFECT PUSHBUTTON SWITCH

(71) Applicant: POLARA ENGINEERING, INC., Corona, CA (US)

(72) Inventors: Brandon J. McGaffey, Royse City, TX (US); Brian J. Beckwith, Riverside, CA (US); Brad P. Whitney, Lafayette, LA (US)

(21) Appl. No.: 14/861,727

(22) Filed: Sep. 22, 2015

Related U.S. Application Data
(60) Provisional application No. 62/053,381, filed on Sep. 22, 2014.

(51) Int. Cl. H01H 50/20; G08G 1/005

(52) U.S. Cl. CPC H01H 50/20; G08G 1/005; H01H 2215/05

(57) ABSTRACT

A pushbutton switch that utilizes a Hall Effect sensor. The Hall Effect pushbutton switch may be utilized in an Accessible Pedestrian Signal (APS) system or in variety of applications where pushbutton movement needs to be measured. The pushbutton switch comprises a pushbutton exposed to a user and slidably received in a pushbutton housing of a pushbutton station. A magnet is attached to the pushbutton at a side opposite to the side exposed to the user. A Hall Effect sensor (either analog or digital) is coupled to a circuit board and positioned in spaced relation to the magnet and pushbutton. For tactile feedback or vibration, the sensor is mounted at the center or within close proximity of a coil. The magnetic field generated from the coil during vibration/tactile feedback can be monitored as a means of self-checking for proper functionality of both the sensor and coil working together.

### CROSS-REFERENCE TO RELATED APPLICATIONS

This application claims the benefit of U.S. Provisional Application No. 62/053,381, filed Sep. 22, 2014, which application is incorporated herein by reference.

### FIELD

The embodiments described herein generally relate to pushbutton switches, more particularly, to a pushbutton switch utilizing a Hall Effect sensor.

### BACKGROUND

Currently the most common method for activating a pedestrian signal interval in most APS (Accessible Pedestrian Signal) systems is via the use of a mechanical contacting switch. This method is prone to failure due to the mechanical wear of the contactors within the switch. Additionally, this method is prone to sticking of the switch either due to buildup of ice or dirt or from intentional continuous activation attributed to vandalism (mechanical jamming, glueing, etc). This design also is prone to failure of the electrical contacts due to electrical overstress caused by improper installation or lightning.

Another method that has been used for activating a pedestrian signal interval in APS systems is the use of piezoelectric sensors that convert a pedestrian push into an electric signal that is interpreted by a microcontroller or other voltage sensing device, which in turn, closes the contacts of the pushbutton to place a pedestrian call. An example of a pushbutton system utilizing a piezoelectric sensor is described in U.S. Pat. No. 6,982,630, entitled “Vibrating Pedestrian Push Button Station”, which patent is incorporated herein by reference. The benefit of this technology is that the push cycle life is far greater than a mechanical switch due to the piezo not having mechanical contacts that can wear out.

In APS systems using piezoelectric sensors, the button is mechanically connected to the piezo element to cause deflection. Piezoelectric sensors translate a mechanical push of the button into a signal proportional to the rate and amount of piezoelectric deflection. Very low power electronic circuits are used to amplify and condition the piezoelectric signal into information such as button pressed or button released. The position of the button can only be inferred during the press and release of the button.

Similarly the piezoelectric sensor produces a signal due to temperature. The piezo-crystal expands differently than the brass base producing a mechanical deflection. With fast temperature changes this deflection cannot be differentiated from a button press.

Manufacturing a reliable piezoelectric sensor system is labor intensive and requires highly skilled operators. For example: a piezoelectric sensor may be easily damaged during manufacture, but the damage is not detectable until after the customer has installed and used the product. From a reliability perspective severe mechanical deflection will produce micro-fractures in the crystal and crystal delamination from the brass base. These defects will reduce the signal output which decreases the sensitivity of the output signal.

Because the piezoelectric sensor does not convert mechanical deflection into absolute position, certain APS product features such as, e.g., absolute position of the button, detection of long pushes (e.g. 60 seconds or more), and detection of a missing button, are not possible without significant expense and compromise.

Accordingly, it is desirable to provide a pushbutton for an APS comprising a reliable switch mechanism that is adaptable to varying switch activation/release forces for the purpose of activating pedestrian signal intervals.

### SUMMARY

The embodiments described herein are directed to pushbutton switch systems that utilizes a Hall Effect sensor. For ease of illustration, this pushbutton switch system will be described as a pushbutton switch for use in an APS (Accessible Pedestrian Signal) system. However, in its broadest sense, the Hall Effect pushbutton switch can be any type of pushbutton switch for use in a variety of applications where movement of the pushbutton needs to be measured, or where tactile feedback indicating a process has been started, is under way or ends is required. In certain embodiments, a pushbutton switch system comprises a pushbutton exposed to a user and a magnet attached to the pushbutton at an underside or a side of the pushbutton opposite to the side exposed to the user. A Hall Effect sensor (either analog or digital depending on desired features) is coupled to a circuit board and positioned in spaced relation to the magnet and pushbutton. If the switch application requires tactile feedback or vibration, the sensor could be mounted at the center or within close proximity of a coil. In this configuration, the magnetic field generated from the coil during vibration/tactile feedback can be monitored as a means of self-checking for proper functionality of both the sensor and coil working together.

In other embodiments such as, e.g., a pushbutton switch of a pushbutton station for an APS system, the pushbutton switch comprises a pushbutton exposed to a user and slidably received in a pushbutton housing, which is coupled to an enclosure for a pushbutton station. A magnet is attached to the pushbutton at an underside or a side of the pushbutton opposite to the side exposed to the user. A Hall Effect sensor (either analog or digital depending on desired features) is coupled to a circuit board and positioned in spaced relation to the magnet and pushbutton. If the switch application requires tactile feedback or vibration, the sensor could be mounted at the center or within close proximity of a coil. In this configuration, the magnetic field generated from the coil during vibration/tactile feedback can be monitored as a means of self-checking for proper functionality of both the sensor and coil working together.

The Hall Effect sensor comprises a Hall Effect element that is preferably a small piece of semiconductor material with current passing between two electrodes on opposite ends. Electrodes placed on the other two sides are used to detect a change of current between the first two electrodes. A properly applied magnetic field will cause a deflection of the current from the first two electrodes to one of the side electrodes. Hence measurement of the side electrodes is directly proportional to the strength and polarity of the magnetic field. Thus, by using a Hall Effect element to sense the strength of the magnetic field, the absolute position of the button (containing a magnet) is measureable.

Other systems, methods, features and advantages of the example embodiments will be or will become apparent to one with skill in the art upon examination of the following figures and detailed description.

### BRIEF DESCRIPTION OF THE FIGURES

The details of the example embodiments, including structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1 is a partial cross-sectional schematic view showing a Hall Effect pushbutton switch of a pushbutton station for an APS system.

FIG. 2 is a schematic of an example functional circuit diagram of a Hall Effect sensing circuit.

FIG. 3 is a flow diagram illustrating an example of a method of use of the Hall Effect pushbutton switch within an APS system.

It should be noted that elements of similar structures or functions are generally represented by like reference numerals for illustrative purpose throughout the figures. It should also be noted that the figures are only intended to facilitate the description of the preferred embodiments.

### DETAILED DESCRIPTION

Each of the additional features and teachings disclosed below can be utilized separately or in conjunction with other features and teachings to a pushbutton switch with a Hall Effect element. Representative examples of the present invention, which examples utilize many of these additional features and teachings both separately and in combination, will now be described in further detail with reference to the attached drawings. This detailed description is merely intended to teach a person of skill in the art further details for practicing preferred aspects of the present teachings and is not intended to limit the scope of the invention. Therefore, combinations of features and steps disclosed in the following detailed description may not be necessary to practice the invention in the broadest sense, and are instead taught merely to particularly describe representative examples of the present teachings.

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter.

As shown in the figures, the embodiments shown therein are directed to an APS (Accessible Pedestrian Signal) system having a pushbutton switch that utilizes a Hall Effect sensor. For ease of illustration, this pushbutton switch system will be described as a pushbutton switch for use in an APS (Accessible Pedestrian Signal) system. However, in its broadest sense, the Hall Effect pushbutton switch can be any type of pushbutton switch for use in a variety of applications where movement of the button needs to be measured, or where tactile feedback indicating a process has been started, is under way or ends is required.

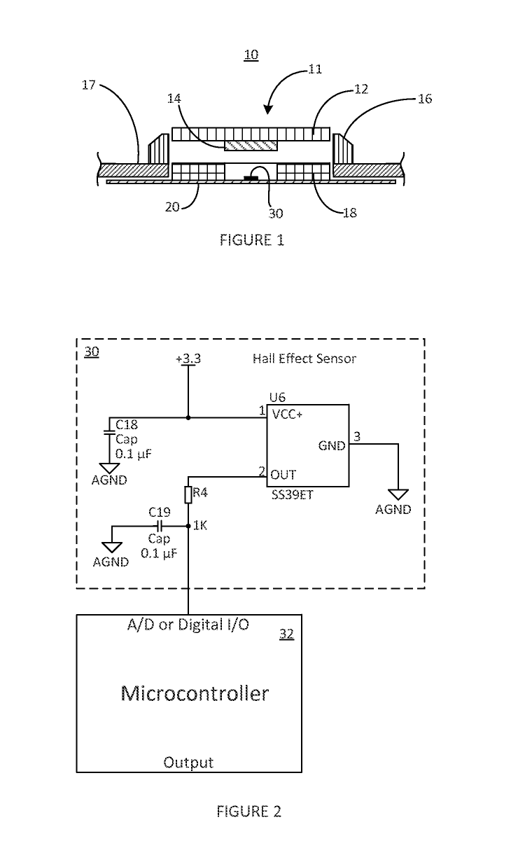

As depicted in FIG. 1, a pushbutton switch 11 of a pushbutton station 10 for an APS system is shown to comprise a pushbutton 12 exposed to a user and slidably received in a pushbutton housing 16, which is coupled to an enclosure 17. A magnet 14 is attached to the pushbutton 12 at an underside or a side of the pushbutton 12 opposite to the side exposed to the user. A Hall Effect sensor 30 (either analog or digital depending on desired features) is coupled to a circuit board 20 and positioned in spaced relation to the magnet 14 and pushbutton 12. If the switch application requires tactile feedback or vibration, the sensor 30 could be mounted at the center or within close proximity of a coil 18. In this configuration, the magnetic field generated from the coil 18 during vibration/tactile feedback can be monitored as a means of self-checking for proper functionality of both the sensor 30 and coil 18 working together.

The Hall Effect sensor 30 comprises a Hall Effect element that is a “small” piece of semiconductor material with current passing between two electrodes on opposite ends. Electrodes placed on the other two sides are used to detect a change of current between the first two electrodes. A properly applied magnetic field will cause a deflection of the current from the first two electrodes to one of the side electrodes. Hence measurement of the side electrodes is directly proportional to the strength and polarity of the magnetic field. Thus, by using a Hall Effect element to sense the strength of the magnetic field, the absolute position of the button 12 containing the magnet 14 is measureable.

The Hall Effect sensor 30 is positioned to sense the magnetic field from the magnet 14 coupled to the button 12, which are movable relative to the sensor 30. Sensor output is measured by means of an analog to digital (A/D) converter on a microcontroller. As the output (either voltage or current) from the sensor fluctuates based on position of the magnet to the sensor, the A/D converter converts this analog signal into discrete digital values depending on the resolution of the A/D converter. After the A/D conversion converts an analog signal to a digital value, thresholds are assigned to these values in software to represent different states, such as, e.g., at rest, travel down, travel up, moving down, moving up, rate of moving, long term change of at rest, missing magnet, wrong polarity magnet, etc. A changing value with respect to time can be used to determine rate of push, at rest state, or long term change of at rest state. Ascending or descending values define the direction of movement. Predefined values at the extremes of the A/D conversion range are used to detect missing magnet or wrong polarity magnet conditions.

Referring to FIG. 2, an example of a function circuit diagram for the Hall Effect sensor 30 is provided. As depicted, the Hall Effect sensor 30 interfaces to a microcontroller 32 either through an analog input (if variable push force detection is desired) or to a digital input (if a single level of push force detection is desired). FIG. 2 is just one example depiction of a functional Hall Effect sensing circuit. Various manufacturers make different Hall Effect sensors with different mounting options, sensitivities, and output modes. All of these options can be easily configured in a circuit to provide the above described functionality.

Depending on the mode of operation of the Hall Effect sensor 30, the sensor's output voltage or current varies based on the strength of magnetic field passing through the sensor 30. The source of this magnetic field originates from the magnet 14, and since the magnetic field strength varies with distance (as the button 12 is pressed or released), the change in magnetic field that occurs is detected by the sensor 30 which results in a change of output voltage/current. This change in output of the sensor 30 is detected by a microcontroller 32 or, optionally, a discrete conditioning/signal processing circuitry which can then further process the signal to provide the switch functionality that the user desires (variable push force, latching output, momentary output, etc.). This change in output signal can be precisely correlated to a specific change in displacement of the button 12 via a transfer function.

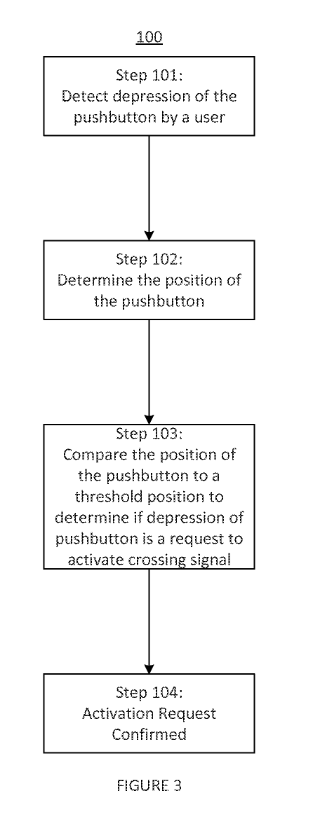

Turning to FIG. 3, an example of a method 100 of use of the Hall Effect pushbutton switch 11 within an APS system is depicted. Prior to operation by a user, the pushbutton is in a resting state where the magnet field strength sensed by the Hall Effect sensor is at a constant or stable value. At step 101, depression of the pushbutton by a user is detected. As noted above, a change in value of the strength of the magnetic field sensed by the Hall Effect sensor is interpreted by the microcontroller to determine if the pushbutton is being pushed in or depressed by a user. At step 102, the position of the pushbutton and magnet is determined based on the voltage and/or current output by the sensor. At step 103, the position of the pushbutton and magnet is compared to a threshold position to determine if the pushbutton and magnet have traveled past the threshold position indicating the depression of the pushbutton was a request to activate the crossing signal. At step 104, the activation request is confirmed.

The Hall Effect pushbutton switch 11 provides a dramatic improvement to the useful life of an APS pushbutton switch because no contact is made between the actuator (magnet) 14 and the sensor (Hall Sensor) 30. Another significant advantage over prior technologies is that the response of the switch as it relates to push force, hysteresis, and debounce are all able to be easily configured in software. Another major improvement of Hall Effect technology is that there are no mechanical interconnects needed between the switch mechanism circuitry and the main control circuit board. The Hall Effect sensor is capable of being surface mountable directly on the control PCB eliminating the possibility of switch failure at the interconnect.

When the switch 11 is installed within an APS that requires tactile feedback of the switch 11, the magnet 14 that activates the sensor 30 can serve a dual purpose by interacting with an on board electromagnet (coil) 18 for the purpose of vibration and haptic response in a manner as described in U.S. Pat. No. 6,982,630, which patent is incorporated herein by reference. In addition to this feature, the Hall Effect sensor 30 can detect the magnetic field generated by the coil 18 during vibration and the sensor 30 can serve to verify the proper function of the coil 18. Unlike piezo technology where the output is dependent on the rate of deflection, the output of a Hall Effect sensor 30 does not vary with the rate of deflection or temperature changes allowing for a continuous, stable output based on magnet position.

Although the present invention has been described and illustrated in the foregoing exemplary embodiments, it is understood that the present disclosure has been made only by way of example, and that numerous changes in the details of implementation of the invention may be made without departing from the spirit and scope of the invention. Features of the disclosed embodiments can be combined and rearranged in various ways. For instance, the present invention can be created inversely to accommodate a different packaging scenario.

In the foregoing specification, the invention has been described with reference to specific embodiments thereof It will, however, be evident that various modifications and changes may be made thereto without departing from the broader spirit and scope of the invention. For example, the reader is to understand that the specific ordering and combination of process actions shown in the process flow diagrams described herein is merely illustrative, unless otherwise stated, and the invention can be performed using different or additional process actions, or a different combination or ordering of process actions. As another example, each feature of one embodiment can be mixed and matched with other features shown in other embodiments. Features and processes known to those of ordinary skill may similarly be incorporated as desired. Additionally and obviously, features may be added or subtracted as desired. Accordingly, the invention is not to be restricted except in light of the attached claims and their equivalents.

What is claimed is:

1. A pushbutton switch system comprising
a pushbutton exposed to a user,
a magnet attached to the pushbutton,
an electromagnetic coil operably coupled to the magnet, and
a Hall Effect sensor operably coupled to the magnet and the coil, and positioned in spaced relation to the pushbutton and magnet.

2. The pushbutton switch of claim 1 wherein the sensor is one of an analog sensor and a digital sensor.

3. The pushbutton switch of claim 1 wherein the coil and sensor are mountable to a printed circuit board.

4. The pushbutton switch of claim 1 wherein the sensor is positioned at the center or within close proximity of the coil.

5. The pushbutton switch of claim 1 wherein the sensor interfaces to a microcontroller.

6. The pushbutton switch of claim 1 wherein the pushbutton is slidably received in a pushbutton housing.

7. The pushbutton switch of claim 6 wherein the pushbutton housing is coupled to a pushbutton station enclosure for an Accessible Pedestrian Signal (APS) signaling system.

8. A pushbutton switch system comprising
a pushbutton exposed to a user,
a magnet attached to the pushbutton, and
a Hall Effect sensor positioned to sense a magnetic field from the magnet.

9. The pushbutton switch of claim 8 further comprising a means to measure the sensor output and translate the output into positional information.

10. The pushbutton switch of claim 9 further comprising a means to relate positional information into different button position states.

11. The pushbutton switch of claim 10 wherein the states include one or more of an at rest state, a travel down state, a travel up state, a moving down state, a moving up state, a rate of moving state, an at rest state, a missing magnet, and a wrong polarity magnet state.

12. The pushbutton switch of claim 8 further comprising an electromagnetic coil operably coupled to the magnet, wherein the electromagnetic coil and magnet interact to provide vibratory or haptic feedback.

13. The pushbutton switch of claim 12 further comprising a means to measure one or more of the button rate of travel and the button direction of travel during vibration of the button.

14. The pushbutton switch of claim 8 wherein the sensor is one of an analog sensor and a digital sensor.

15. The pushbutton switch of claim 8 wherein the sensor is mountable to a printed circuit board.

16. The pushbutton switch of claim 12 wherein the coil and sensor are mountable to a printed circuit board.

17. The pushbutton switch of claim 12 wherein the sensor is positioned at the center or within close proximity of the coil.

18. The pushbutton switch of claim 8 wherein the sensor interfaces to a microcontroller.

19. The pushbutton switch of claim 8 wherein the pushbutton is slidably received in a pushbutton housing.

20. The pushbutton switch of claim 19 wherein the pushbutton housing is coupled to a pushbutton station enclosure for an Accessible Pedestrian Signal (APS) signaling system.
